(19) United States
(12) Patent Application Publication
(10) Pub. No.: US 2024/0274121 A1
(43) Pub. Date: Aug. 15, 2024

(54) PERSONA AND AVATAR SYNTHESIS

(71) Applicant: Perfecta Federal, LLC, Springfield, VA (US)

(72) Inventors: Jawad KAKAR, Springfield, VA (US); George ZOULIAS, Springfield, VA (US)

(21) Appl. No.: 18/228,500

(22) Filed: Jul. 31, 2023

Related U.S. Application Data
(60) Provisional application No. 63/445,450, filed on Feb. 14, 2023.

(51) Int. Cl. G10L 13/047; G06N 20/00; G10L 13/033

(52) U.S. Cl. CPC G10L 13/047; G06N 20/00; G10L 13/033

(57) ABSTRACT

A set of attributes to be generated for a persona used to provide an online presence are identified, in which each attribute in the set includes a predetermined value that indicates a preference for a static mapping algorithm or a machine learning algorithm to generate the each attribute. One or more corresponding features for the each attribute are further specified. The one or more corresponding features are then assembled into a corresponding feature input for the each attribute in the set of attributes. At least one corresponding feature of the corresponding feature input is selected for the each attribute in the set of attributes via static mapping or machine learning provided by the machine learning algorithm based on a corresponding predetermined value. The each attribute of the set of attributes is then synthesized for the persona based on the at least one corresponding feature selected for the each attribute.

### CROSS-REFERENCE TO RELATED PATENT APPLICATION

This application claims priority to U.S. Provisional Patent Application No. 63/445,450, filed on Feb. 14, 2023, entitled “Persona and Avatar Synthesis,” which is hereby incorporated by reference in its entirety.

### BACKGROUND

Presently, online presences can widely vary from application to application, especially where application user interfaces vary. Different user interfaces range in fidelity. Where a user interface is simply text-based, such as Internet Relay Chat and other online chat, an online presence is comprised only of aspects that can be represented in text messages. In contrast, consider a fully implemented metaverse: the online presence can be an avatar, that is an online figure that represents a real person online, where the figure may have the likes of visual aspects, sound aspects, and indeed may have mannerisms consistent with a particular personality, even though not necessarily that of a real person.

The more complex computing user interfaces have become, the more complex it is to author an online presence. Presently, users sometimes choose between making use of a premade avatar or authoring an avatar from scratch. Both options can have suboptimal qualities. For example, the former may not afford a wide range of choices. The latter typically involves making use of computer art tools and programming out of reach to most users. The result is a lack of a wide range of options for online presences and avatars alike.

Accordingly, there is a need for novel techniques to generate an online presence, and/or an avatar, that may be used for an arbitrary online computer application.

### DESCRIPTION OF THE FIGURES

The detailed description is described with reference to the accompanying figures. In the figures, the left-most digit(s) of a reference number identifies the figure in which the reference number first appears. The same reference numbers in different figures indicate similar or identical items.

FIG. 1 is a context diagram for the implementation of persona and avatar synthesis.

FIG. 2 is a block diagram of an exemplary environment for the implementation of persona and avatar synthesis.

FIG. 3 is a flow diagram of an example process for implementing persona and avatar synthesis.

### DETAILED DESCRIPTION

### Context of Persona and Avatar Synthesis

A persona may comprise a set of features or attributes that a real human being focuses on to identify characteristics about a person, whether real or virtual. In some aspects, a persona generally relates to a class of people with expected traits and behaviors. For example, in a software specification, a persona may be defined as part of specifying user classes and scenarios that people represented in the user class will perform. In the case of online presences, a persona can therefore be considered to at least include a set of self-consistent attributes that accurately represent a desired class of person.

In some examples, attributes may range from physical attributes such as the height, weight, race, and gender of the person, to speech mannerisms such as accent, dialect, and particles (such as the Canadian “eh”, the Philadelphia “jawn”, and the New York City “fuggetaboutit”). Other attributes may relate to choice of dress or fashion, or other behavioral attributes.

User interfaces are able to represent some attributes, but may not be able to represent others. In some examples, a class of attributes representable by a user interface may be called an aspect of the persona. A user interface may enable the representation of multiple aspects.

This grouping of attributes to aspects which are in turn mapped to attributes that can be represented by a particular user interface organizes the synthesis of a persona. Say that a persona is to be synthesized for a text interface. Automation techniques can identify the aspects of a persona that can be represented by the specific text interface, and then the corresponding attributes generated. Furthermore, the generation can be based on specifying generalizations about a desired personality rather than exhaustively populating attributes of aspects by hand. For example, if one may specify that they are seeking to generate a persona of a 50-year-old Filipino male based in Seattle, the automation will select the attributes to be modeled, and then will synthesize each of the attributes based on how such a person is likely to appear and behave in the context of the text interface.

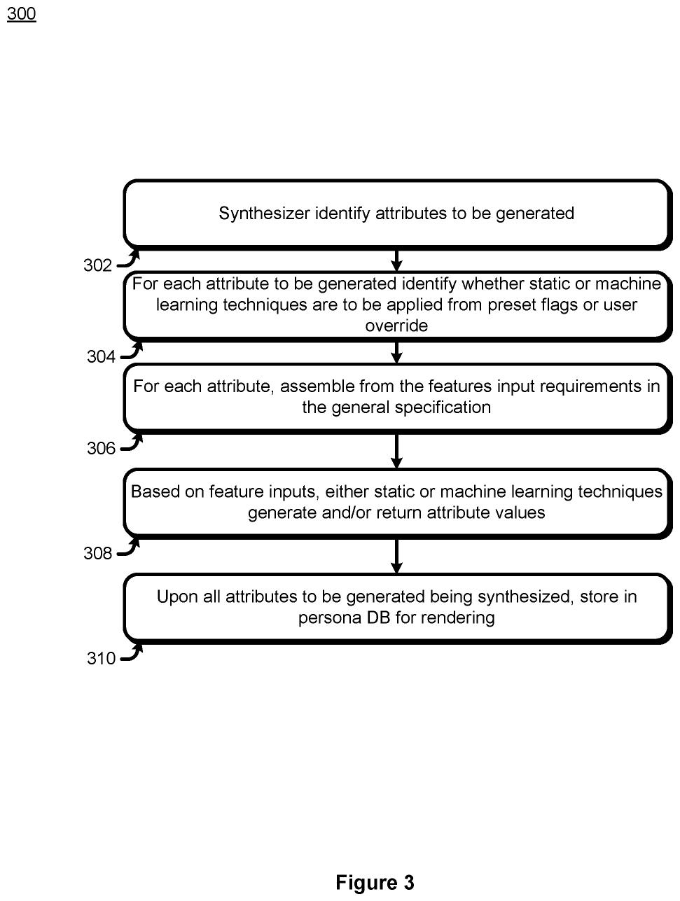

As a result, instead of describing a persona to author or synthesize a persona, one can instead specify what kind of person to model. This represents an improvement at least in enabling a user to specify a persona in personality terms, terms a user is more likely to relate to, rather than artistic tools and programming. This process is described in more detail with respect to FIG. 3 below.

In some aspects, avatars may be contrasted with personas. In others, avatars may be considered a kind of persona that interacts in a graphical and audio manner. Avatars are often used in Massively Multiplayer Online Role Playing Game (MMORPG) environments. A generalization of MMORPGs is the use of avatars for online environments that simulate substantively real time interaction and mimic real world interactions. One example is the proposed Metaverse by Meta Platforms, Inc.

As time has progressed, so too has the fidelity of avatars. In the past, a graphical icon was used with minor animations. Presently, a fully realized image with voice sounds and/or at least physical characteristics is the norm for such online gaming as DOTA and the like. As the number of persona attributes that can be represented has increased, so too has the complexity of authoring a persona.

As previously stated, users presently choose between making use of a premade avatar or authoring an avatar from scratch. This does not afford a wide range of options. However, options can be both desirable and critical for users. Consider an online space with a thousand users. In this context, there may be a need for a thousand avatars. Furthermore, if the avatars are not distinctive (e.g., the online space offers only thirty avatars with minor changes), interactions between users on how to identify each other may have to use different semantics than those represented solely by the avatar—which defeats the purpose of having an avatar in the first place.

Presently, computing user interface research refers to “the uncanny valley”, which maps the emotional response of a person to the degree of accuracy and anthropomorphism of an artificial representation. Specifically, there is a hypothesized place where the degree of accuracy and anthropomorphism is great, but such that its artificial nature can still be detected—a negative response. On the chart, the negative response is represented as a dip or “valley” in the chart, hence the term “uncanny valley.” However, the location of the uncanny valley is still not precisely identified.

Accordingly, where the end goal is to make a fully anthropomorphic avatar (or persona), the techniques disclosed herein enable the management of a large number of attributes to get to an arbitrarily high degree of anthropomorphism to avoid the uncanny valley. As a result, a user can design an avatar or persona to overcome the uncanny valley in any context.

### Overview of Persona and Avatar Synthesis

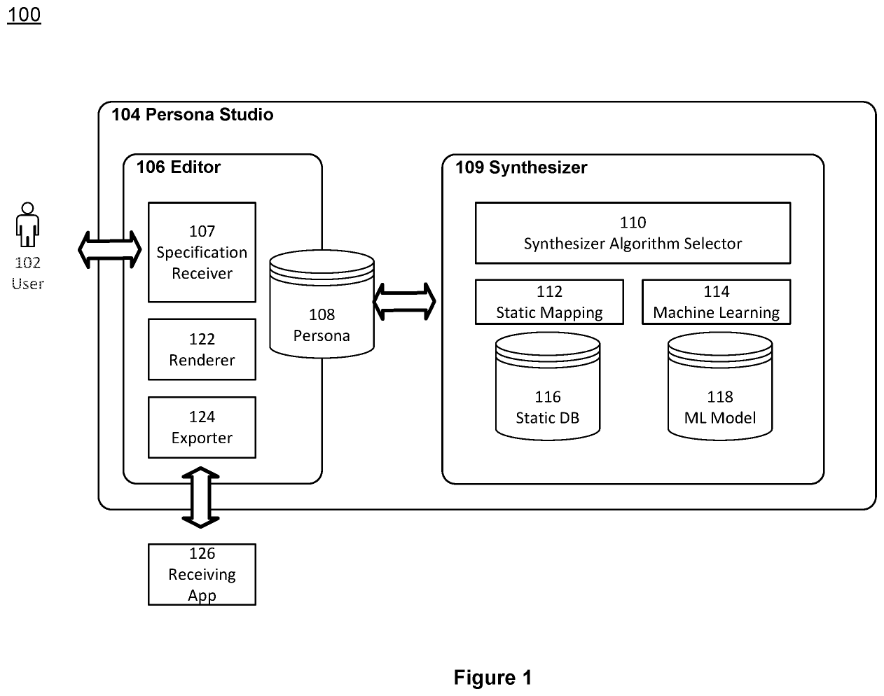

FIG. 1 is a context diagram 100 providing an overview of Persona and Avatar Synthesis. Specifically, one or more features of a generalized persona specification is received, entered, and/or created, and an automated synthesizer generates a persona comprised of a plurality of attributes, where one or more of the features are used as input for attributes of the persona to be synthesized on a one-to-many or many-to-many basis. For example, a feature can be used as input for multiple attributes, and an attribute may be synthesized as a function of multiple features. Upon synthesis, the persona can be further edited, rendered for preview, and/or exported. In some examples, the user may have the opportunity to approve the persona before export.

A user 102 may work with a persona studio 104 that may include a persona editor 106, which in turn may include a specification receiver 107. In some examples, the user 102 may enter one or more features of a generalized persona specification into the specification receiver 107. The generalized persona specification may be comprised of a set of features which the specification receiver stores in a persona data store 108.

With the population of persona features in the persona data store 108, a synthesizer 109 may receive a software notification and identify the attributes of the persona to be synthesized. This is performed by a synthesizer algorithm selector 110, which is part of the synthesizer 109. If the received generalized persona specification corresponds to a target application, or features that are limited to one or more target applications, then the persona to be synthesized may be limited to the attributes and aspects mapping to the identified target application or target applications. However, in some examples, the synthesizer algorithm selector 110 may select all attributes and store placeholders for those attributes in the persona data store 108.

In some embodiments, the synthesizer algorithm selector 110 may select either a static mapping algorithm 112 or a machine learning algorithm 114. A static mapping algorithm takes static resources from a static resource database 116 and creates attributes as an amalgamation of those static resources. For example, consider the generation of a face which is to have a mustache. The static resource database 116 may contain a pre-stored set of images of several hundred mustaches, each with one or more static tags. Based on one or more features in the general specification, the static resource database 116 may return a set of mustaches in response to a query. For example, a query for a young man in his 20's with an Italian ethnic background, from Brooklyn, may return images with static tags that map to the features specified, possibly with darker and/or curlier hair, with trim styles relating to contemporary Brooklyn if so tagged, however narrowly or even biased. Depending on predetermined settings, the user may select a mustache, or an amalgamation of the mustaches may be returned. Amalgamation of the mustaches can be achieved using computer morphing algorithms, for example.

One possible problem with static mapping is that it presumes that the images are tagged with data of interest and the mapping of the feature specifications to tags pre-exist. Sometimes, this may be the case. However, machine learning algorithms 114 may lend themselves better where tags cannot be pre-identified and therefore attached as static tags.

For machine learning algorithms 114, a machine learning database 118 may contain one or more trained models comprised of images selected in past uses of the persona studio 104. With the features in the general specification, for example the same request for a mustache of a 20-year-old man from Brooklyn with Italian ancestry, the machine learning algorithm 114 may return one or more mustache images, or alternatively an amalgamation of the mustache images. One benefit is that the machine learning algorithm 114 may return images that are more realistic rather than relying on broad generalizations and tropes.

Selection by the synthesizer algorithm selector 110 may be based on either user choice/specification, or the attributes to be generated. Specifically, some attributes may be generated more accurately with static mapping and some may be generated more accurately with machine learning. Static mapping and machine learning for persona attribute synthesis are described in more detail with respect to FIG. 3 below.

The synthesizer 109 may send the attributes to the persona database 108. Upon population, the persona database 108 may send out a software notification to a renderer 122 in the editor 106. Renderer 122 can display an image and potentially a sound rendering of a persona, or avatar, generated by the synthesizer 109, and stored as attributes in persona data store 108.

Renderer 122 generally may enable the viewing of the figure and/or face of the generated persona or avatar. Renderer 122 will have controls to move, pan, and rotate the figure. In at least one example, the user 102 may be given the opportunity to review the synthesized mustache and directly edit the mustache using editing tools in the renderer. Alternatively, or additionally, the user 102 may be able to modify the generalized specification and enter into the specification receiver 107 for re-synthesis by synthesizer 109 and re-rendering by renderer 122.

Renderer 122 will in general have a number of tools to test different attributes. For example, voice rendering can be achieved with a tool that receives a text message and is played back with the persona voice according to generated attributes. In some embodiments, behaviors can be reviewed by invoking commands to respond to predetermined situations, such as greeting, confrontation, or the like.

Accordingly, the synthesized persona may be exported via an exporter 124, which generates a persistence file of the synthesized attributes. In some cases, the exporter may have a format for a known application. In such cases, the exporter may generate a file to create an avatar conforming to the relevant application.

### Exemplary Environment for Persona and Avatar Synthesis

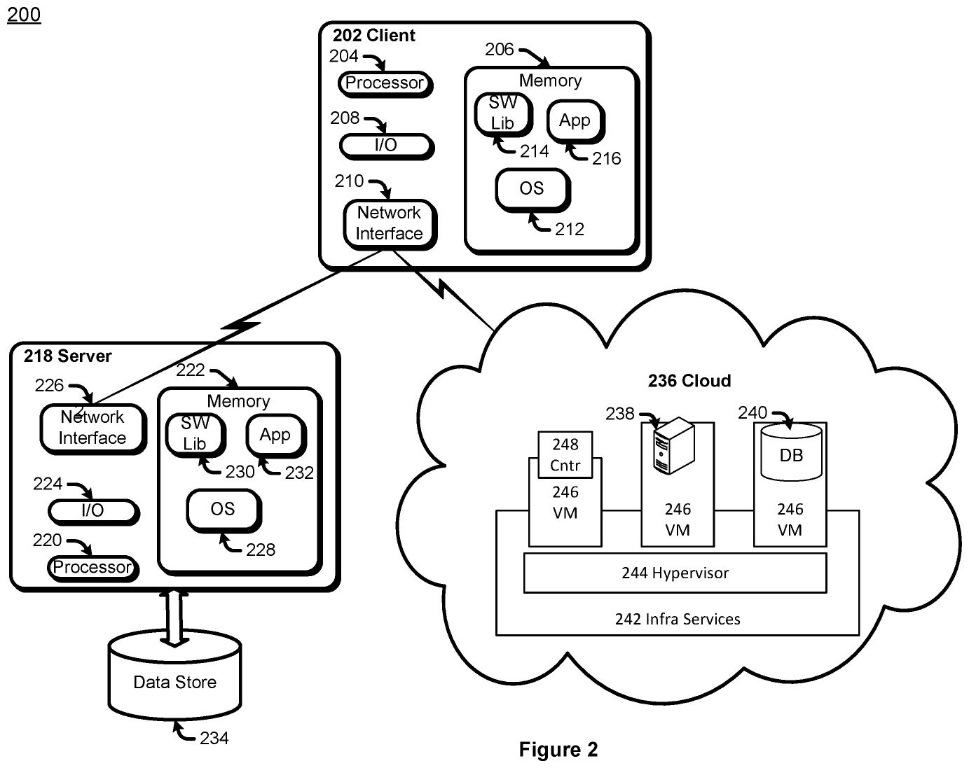

FIG. 2 depicts a diagram 200, including an exemplary hardware, software, and communications computing environment. The functionality for Persona and Avatar Synthesis is generally hosted on a computing device in the depiction. Exemplary computing devices may include, without limitation, personal computers, laptops, embedded devices, tablet computers, smartphones, and/or virtual machines. In many cases, computing devices are to be networked.

One computing device may be a client computing device 202. The client computing device 202 may have a processor 204 and a memory 206. The processor may be a central processing unit, a repurposed graphical processing unit, and/or a dedicated controller such as a microcontroller. The client computing device 202 may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210, may potentially work in concert with the I/O interface 208 and may be a network interface card supporting Ethernet and/or Wi-Fi and/or any number of other physical and/or datalink protocols.

Memory 206 may be any computer-readable media that may store software components including an operating system 212, software libraries 214, and/or software applications 216. In general, a software component is a set of computer-executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media may include, at least, two types of computer-readable media, namely computer storage media and communications media. Computer storage media includes volatile and non-volatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media does not include communication media.

A server 218 may be any computing device that may participate in a network. The network may be, without limitation, a local area network (“LAN”), a virtual private network (“VPN”), a cellular network, or the Internet. The server 218 is similar to the host computer for the image capture function. Specifically, it will include a processor 220, a memory 222, an input/output interface 224, and/or a network interface 226. In the memory will be an operating system 228, software libraries 230, and server-side applications 232. Server-side applications include file servers and databases including relational databases. Accordingly, the server 218 may have a data store 234 comprising one or more hard drives or other persistent storage devices.

A service on the cloud 236 may provide the services of a server 218. In general, servers may include or embody a physical dedicated server, or may be embodied in a virtual machine. In the latter case, the cloud 236 may represent a plurality of disaggregated servers that provide virtual application server 238 functionality and virtual storage/database 240 functionality. The disaggregated servers are physical computer servers, which may have a processor, a memory, an input/output (I/O) interface and/or a network interface. The features and variations of the processor, the memory, the I/O interface and the network interface are substantially similar to those described for the server 218. Differences may be where the disaggregated servers are optimized for throughput and/or for disaggregation.

Cloud services 236 that include the virtual application server 238 and the database 240 may be made accessible via an integrated cloud infrastructure 242. Cloud infrastructure 242 not only provides access to cloud services 236 but also to billing services and other monetization services. Cloud infrastructure 242 may provide additional service abstractions such as Platform as a Service (“PAAS”), Infrastructure as a Service (“IAAS”), and Software as a Service (“SAAS”).

As previously stated, one difference between a physical server 218 or plurality of physical servers 218 arranged into a server farm is that the service provider may make use of one or more hypervisors 244 to disaggregate the physical servers 218. Specifically, a hypervisor 244 tracks what physical server 218 services (including but not limited to compute, storage, input/output/network, and analytics such as via graphical processing units) are utilized and which are free. The hypervisor 244 acts like a scheduler for these services. When a hypervisor 244 receives a request for a virtual machine with a particular configuration, the hypervisor 244 selects services from the various physical servers 218 and creates a virtual machine 246 whose underlying hardware is from the selected services.

The instantiated virtual machine 246 is a software emulator that runs a selected computing instruction set architecture (ISA) such as x86, x64, or RISC-V. The hypervisor 244 configures the virtual machine 246 with an operating system of choice, provisions it with accounts of the requestor, and may install applications as desired. Typical applications include but are not limited to application servers 238 and database servers 240. The effect is that a requester only pays for requested computing services and can thereby both control (right-size) and outsource information technology (IT) services.

Because provisioning and booting an operating system on the virtual machine 246 take time, computer requests on the virtual machine 246 are delayed by that provisioning and boot time. However, in some cases, a request desires an on-demand, near real-time response. In the past, virtual machines 246 have been pre-instantiated in a pool. However, this assumes that the pre-instantiated virtual machines have substantially the same functionality as a request. This is often not the case.

Accordingly, containers 248, which are on-demand partitions of an already instantiated virtual machine 246, may be served to respond to a compute request. As its name implies, a container 248 is a subset of functionality of an instantiated virtual machine 246 where the container 248 is instantiated according to the compute request. Because all container 248 computing resources are already instantiated in the pre-instantiated virtual machine 246, there is no provisioning or boot time lag, and because only the requested computing resources in the container are served to the requestor, the requestor only pays for the requested computing resources, not for the entire virtual machine 246. The result is that requestors can get right-sized computing resources on demand in near real time. This is the premise of elastic computing.

Attribute Generation from Features

FIG. 1 describes end-to-end the synthesis of a persona. However, a persona may be comprised of multiple attributes. An advantage of the techniques described herein is that the generation of a persona need not require each and every attribute to be populated. In practice, a persona may be comprised of hundreds of attributes. Some attributes may relate to physical features such as facial features. Other attributes may be auditory and may relate to voice sounds. Yet others may be behavioral and relate to mannerisms or activity. It can be both difficult and undesirable to manually track all these attributes in such a way to ensure consistency.

Accordingly, a generalized specification of a persona made up of multiple features is described herein. An attribute of a persona may be a function of one or more features from the generalized specification. In general, the cardinality of features and attributes is one-to-many or many-to-many—a feature can be used as input for multiple attributes, and an attribute may be synthesized as a function of multiple features.

Beyond cardinality, features may be articulated in personal and/or cultural terms that a user 102 might use in general to describe a person to another person. Attributes may be exhaustive lists of key-value pairs more suitable for a computer and/or database storage. Thus, the persona studio 104 and related technologies lend themselves to a more user-friendly way to specify a persona or avatar. FIG. 3 is a flow diagram 300 of this process.

In block 302, synthesizer 109 may identify a set of attributes to generate. Synthesizer 109 has a predetermined set of attributes. If the target application for which the persona is to be generated is not known, all predetermined attributes may be generated. Otherwise, only the attributes for the target application or applications may be generated.

For each attribute to be generated, synthesizer 109 may have a predetermined value indicating whether static mapping or machine learning is the preferred algorithm. Alternatively, a preference can be set by user 102 in the form of an override flag. In block 304, static mapping or machine learning is selected based on the predetermined value and any user flags set.

For each attribute to be generated, the synthesizer 109 may specify one or more features to be interpreted as input. In block 306, the feature input for the attribute to be generated may be assembled. Where a feature is specified by the general specification, that feature is used. Where features are not explicitly specified, feature values may be inferred using inference/logical programming techniques. Alternatively, feature inputs can be populated with default values. Where a feature cannot be inferred or there is no default value, it may be left blank.

In block 308, a set of candidate attributes may be returned either using static techniques 112 or machine learning techniques 114 based on feature inputs. This set of candidate attributes may be ranked for selection by user 102. Alternatively, a weighted amalgamation may be returned. In block 310, all attributes may be generated and stored in the persona database 108 for later retrieval and rendering.

Note that as the persona database 108 accrues synthesized personas exported by user 102, this represents data that can be used to further augment the machine learning database 118. Accordingly, personas upon export can be used as machine learning training data.

### Use Cases for Persona and Avatar Synthesis

The richness of the aforementioned techniques enable a wide range of use cases. In a sense, the persona database 108 may be considered a mapping of aspects of a persona, i.e., sets of attributes to personas consistent with those aspects. For example, one might not be surprised to find a persona for a young female to have an aspect of the persona, namely choice of clothing, to be clothing for the young miss youth market. Similarly, one might not be surprised to find a persona for an older male with an aspect of the persona, namely choice of transportation, to be a sports car reflecting a certain mid-life preference.

A problem with the aforementioned is that much of this mapping may be based on generalizations and tropes. In turn generalizations and tropes do not lend themselves to believability, or at least exhibit signs of falsity. The fear is that generalizations and tropes will place the generated persona into the uncanny valley.

The hope is that the use of a large amount of attributes and the use of computer algorithms will make such mappings less based on biases and more based on data.

One use case therefore is to query the persona database 108, or to make use of the machine learning models to specify attributes of one persona aspect, and to generate a full persona comprised of other aspects. One example is that one can sample a voice and generate voice attributes for a persona. These attributes may be collected into an aspect and personas that best match the voice attributes can be returned. Note that full personas will frequently include other aspects such as face, figure, choice of clothes, and the like. In other words, the aforementioned techniques can receive a voice sample and generate a likely face to match.

Another use case is to measure believability. Whenever an attribute is generated from machine learning, a confidence score can be generated as well. When creating an aspect, which is a set of attributes, the confidence scores can be amalgamated into an overall score for the aspect. In such a use case, each attribute may be generated by machine learning where the machine learning algorithms make the best statistical fit based on the inputs the machine learning algorithm receives. For example, if the persona is to be an ethnically Filipino male from the US in his mid-fifties, the synthesizer may generate a persona with a face with a lighter color than younger Filipinos, with some graying facial hair, and with a heavier set. Upon generation, because the generation is based on a statistical fit, the machine learning algorithms may also provide a confidence level for each generated attribute, e.g., Error %+Confidence %=100%. Thus, if a machine learning algorithm for generating an attribute in the form of facial hair is known to have an error rate of 5%, the confidence score would be 95%.

Accordingly, the overall score for the aspect, or a believability score for the aspect of a persona, may be calculated based on the confidence scores and corresponding statistical weights for a set of attributes of the aspect. For example, the believability score for a set of attributes that includes attributes such as skin tone color, facial hair color, and weight may be calculated as follows, in which each conf % represents a corresponding confidence score, and the values 0.4, 0.5, and 0.1 are the respective statistical weights:

$$Believability score = Skin Tone Color conf \% \times ( 0.4 ) + Facial Hair Color conf \% \times ( 0.5 ) + Heavyset conf ( \% ) \times ( 0.1 )$$

In this example, if the confidence scores for the skin tone color, facial hair color, and weight are 97%, 93%, and 94%, respectively, the believability score for the aspect may be calculated as follows:

$$97 \% ( 0.4 ) + 93 \% ( 0.5 ) + 94 \% ( 0.1 ) = 38.8 \% + 46.5 \% + 9.4 \% = 94.7 \%$$

Thus, this means that the amalgamated overall score for the aspect in this example, i.e., the believability score, is 94.7%.

Consider an example where a generated face is to be superimposed on a picture. The attributes of the rest of the picture, including clothing, setting, expressions, can be retrieved, and the persona database 108 or machine learning database 118 queried for confidence scores for the face to be superimposed. Note that these confidence scores represent correlation of the superimposed face on the rest of the picture. Accordingly, if the confidence levels were below a predetermined threshold, such as 85%, a warning could be surfaced to the user 102, or the picture could be blocked from the superimposition.

These are only a small set of use cases made possible with the techniques disclosed herein. In short, much more believable personas and avatars can be synthesized by ensuring that aspects of an entire persona are self-consistent and consistent with each other, and consistent with the context that the persona is placed.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more non-transitory computer-readable media storing computer-executable instructions that upon execution cause one or more processors to perform acts comprising:
identifying a set of attributes to generate for a persona that is used to provide an online presence, each attribute in the set of attributes including a predetermined value that indicates a preference for a static mapping algorithm or a machine learning algorithm to generate the each attribute;
specifying one or more corresponding features for the each attribute in the set of attributes;
assembling the one or more corresponding features as a corresponding feature input for the each attribute in the set of attributes;
selecting at least one corresponding feature of the corresponding feature input for the each attribute in the set of attributes via static mapping provided by the static mapping algorithm or machine learning provided by the machine learning algorithm based on a corresponding predetermined value included in the each attribute; and
synthesizing the each attribute of the set of attributes for the persona based on the at least one corresponding feature selected for the each attribute.

2. The one or more non-transitory computer-readable media of claim 1, wherein the acts further comprise storing the set of attributes synthesized for the persona in a database for later retrieval and rendering.

3. The one or more non-transitory computer-readable media of claim 1, wherein the acts further comprise providing the set of attributes synthesized for the persona as machine learning training data for training the machine learning algorithm to select additional corresponding features for synthesizing attributes for personas.

4. The one or more non-transitory computer-readable media of claim 3, wherein the identifying includes using one or more machine learning models to specify one or more attributes that are associated with an aspect of a persona.

5. The one or more non-transitory computer-readable media of claim 4, wherein the aspect of the persona includes a voice associated with the persona, a face associated with the persona, a figure associated with the persona, or a choice of clothing associated with the persona.

6. The one or more non-transitory computer-readable media of claim 1, wherein the specifying includes specifying the one or more corresponding features as the input based at least on a general specification or a logical programming technique.

7. The one or more non-transitory computer-readable media of claim 1, wherein the set of attributes of the persona include one or more voice attributes that are based on a voice sample.

8. The one or more non-transitory computer-readable media of claim 1, wherein the selecting includes selecting at least one feature for an attribute via the machine learning provided by the machine learning algorithm, and wherein the acts further comprise generating a confidence score that is associated with the attribute for the selecting of the at least one feature for the attribute via the machine learning.

9. The one or more non-transitory computer-readable media of claim 8, wherein the attribute is associated with an aspect of the persona, and wherein the acts further comprise amalgamating the confidence score with one or more other confidence scores associated with one or more other attributes of the aspect of the persona to generate an overall score for the aspect.

10. The one or more non-transitory computer-readable media of claim 9, wherein the acts further comprise in response to the confidence score and the one or more other confidence scores being below a predetermined threshold, surfacing a warning regarding the aspect or blocking a superimposition of the aspect with one or more other aspects of the persona.

11. A system, comprising:
one or more processors; and
memory including a plurality of computer-executable components that are executable by the one or more processors to perform a plurality of actions, the plurality of actions comprising:
identifying a set of attributes to generate for a persona that is used to provide an online presence, each attribute in the set of attributes including a predetermined value that indicates a preference for a static mapping algorithm or a machine learning algorithm to generate the each attribute;
specifying one or more corresponding features as input for the each attribute in the set of attributes;
assembling the one or more corresponding features as a corresponding feature input for the each attribute in the set of attributes;
selecting at least one corresponding feature of the corresponding feature input for the each attribute in the set of attributes via static mapping provided by the static mapping algorithm or machine learning provided by the machine learning algorithm based on a corresponding predetermined value included in the each attribute; and
synthesizing the each attribute of the set of attributes for the persona based on the at least one corresponding feature selected for the each attribute.

12. The system of claim 11, wherein the actions further comprise storing the set of attributes synthesized for the persona in a database for later retrieval and rendering.

13. The system of claim 11, wherein the actions further comprise providing the set of attributes synthesized for the persona as machine learning training data for training the machine learning algorithm to select additional corresponding features for synthesizing attributes for personas.

14. The system of claim 13, wherein the identifying includes using one or more machine learning models to specify one or more attributes that are associated with an aspect of the persona.

15. The system of claim 14, wherein the aspect of the persona includes at least one of a voice associated with the persona, a face associated with the persona, a figure associated with the persona, or a choice of clothing associated with the persona.

16. The system of claim 11, wherein the set of attributes of the persona includes one or more voice attributes that are based on a voice sample.

17. The system of claim 11, wherein the selecting includes selecting at least one feature for an attribute via the machine learning provided by the machine learning algorithm, and wherein the acts further comprise generating a confidence score that is associated with the attribute for the selecting of the at least one feature for the attribute via the machine learning.

18. The system of claim 17, wherein the attribute is associated with an aspect of the persona, and wherein the acts further comprise amalgamating the confidence score with one or more other confidence scores associated with one or more other attributes of the aspect of the persona to generate an overall score for the aspect.

19. The system of claim 18, wherein the acts further comprise in response to the confidence score and the one or more other confidence scores being below a predetermined threshold, surfacing a warning regarding the aspect or blocking a superimposition of the aspect with one or more other aspects of the persona.

20. A computer-implemented method, comprising:
identifying, via one or more computing devices, a set of attributes to generate for a persona that is used to provide an online presence, each attribute in the set of attributes including a predetermined value that indicates a preference for a static mapping algorithm or a machine learning algorithm to generate the each attribute;
specifying, via the one or more computing devices, one or more corresponding features as input for the each attribute in the set of attributes;
assembling, via the one or more computing devices, the one or more corresponding features as a corresponding feature input for the each attribute in the set of attributes;
selecting, via the one or more computing devices, at least one corresponding feature of the corresponding feature input for the each attribute in the set of attributes via static mapping provided by the static mapping algorithm or machine learning provided by the machine learning algorithm based on a corresponding predetermined value included in the each attribute; and
synthesizing, via the one or more computing devices, the each attribute of the set of attributes for the persona based on the at least one corresponding feature selected for the each attribute; and
storing the set of attributes synthesized for the persona in a database for later retrieval and rendering.
